(19) United States
(12) Patent Application Publication
(10) Pub. No.: US 2025/0257784 A1
(43) Pub. Date: Aug. 14, 2025

(54) VIBRATION DAMPER UNIT

(71) Applicant: Vibracoustic SE, Weinheim (DE)

(72) Inventors: Ersan Altinoluk, Hamburg (DE); Dieter Bulling, Wedemark (DE)

(21) Appl. No.: 19/052,396

(22) Filed: Feb. 13, 2025

(30) Foreign Application Priority Data
Feb. 13, 2024 (DE) DE102024103970.1

(51) Int. Cl. F16F 9/44; F16F 9/58

(52) U.S. Cl. CPC F16F 9/44; F16F 9/58; F16F 2230/0005

(57) ABSTRACT

A vibration damper unit, through which a longitudinal axis projects, includes a damper with a stop cover element arranged on the end; a foot point adjusting device; a counterbearing, which is situated opposite the foot point adjusting device along the longitudinal axis; a spring, which is supported at one end on the foot point adjusting device; and at the other end on the counterbearing, an auxiliary spring, which is arranged between the foot point adjusting device and the counterbearing and is situated opposite the stop cover element along the longitudinal axis. In embodiments, the stop cover element is connected, connectable, coupled or couplable to the foot point adjusting device.

### CROSS-REFERENCE TO RELATED APPLICATION

This application claims priority to German Patent Application No. DE102024103970.1, filed on Feb. 13, 2024, the content of which is hereby incorporated by reference in its entirety.

### TECHNICAL FIELD

The invention relates to vibration damper units.

### BACKGROUND

A vibration damper unit which comprises a damper with a stop cover element arranged in a fixed manner on the end is known in practice. Furthermore, it has a foot point adjusting device, a counterbearing, which is situated opposite the foot point adjusting device along the longitudinal axis, a spring, which is supported at one end on the foot point adjusting device and at the other end on the counterbearing, and an auxiliary spring. The auxiliary spring is arranged between the foot point adjusting device and the counterbearing and is situated opposite the stop cover element along the longitudinal axis.

The freight loading of the motor vehicle having a vibration damper unit of this kind leads to the spring thereof being compressed and to the level of the motor vehicle being lowered. The original level for the laden motor vehicle is re-established by adjusting a foot point of the compressed spring. However, this also re-establishes an original spacing between the auxiliary spring and the stop cover element (auxiliary spring travel), which determines the maximum spring travel. This spacing between the auxiliary spring and the stop cover element is actually provided for unladen vehicles. The spring preloaded as a function of the freight load, on the other hand, is assigned a maximum spring travel which is provided for a completely different freight loading state, e.g. for an unladen state.

In this state, however, the spring is already preloaded by the freight load. If additional dynamic loading is added to this with the same spring travels as before adjustment of the foot point, e.g. during the trip, the spring may fail. There is therefore a problematic situational discrepancy between the spacing between the auxiliary spring and the stop cover element, on the one hand, and the spring preloading, on the other.

### SUMMARY

An object of the invention is to provide vibration damper units that address one or more of the various challenges associated with conventional damper units.

Aspects and features of the invention are disclosed herein.

According to the invention, the proposal is for a vibration damper unit, through which a longitudinal axis projects, comprising a damper with a stop cover element arranged on the end, a foot point adjusting device, a counterbearing, which is situated opposite the foot point adjusting device along the longitudinal axis, a spring, which is supported at one end on the foot point adjusting device and at the other end on the counterbearing, an auxiliary spring, which is arranged between the foot point adjusting device and the counterbearing and is situated opposite the stop cover element along the longitudinal axis, wherein the stop cover element is connected, connectable, coupled or couplable to the foot point adjusting device.

It has been recognized that freeing the stop cover element from the damper and assigning the stop cover element to the foot point adjusting device overcomes the abovementioned problems. The stop cover element is adjustable by means of the foot point adjusting device. The stop cover element can be adjustably connected, connectable, coupled or couplable to the foot point adjusting device. The connection or connectability between the stop cover element and the foot point adjusting device can be direct. The coupling or couplability between the stop cover element and the foot point adjusting device can be indirect. An adjustment of the foot point adjusting device can move the stop cover element and the auxiliary spring towards one another in relative terms in order to set the auxiliary spring travel and, at the same time, to set the spring travel of the spring. The auxiliary spring can be, for example, an elastomeric auxiliary spring, preferably consisting of a microcellular polyurethane or a compact elastomer.

By virtue of the fact that the stop cover element is connected, connectable, coupled or couplable to the foot point adjusting device, it is possible to make two different aspects dependent on one another, namely, on the one hand, the spacing between the auxiliary spring and the stop cover element (auxiliary spring travel) and, on the other hand, a spring preload. By means of the foot point adjusting device, the stop cover element can be adjusted into a position which corresponds to the spring preload. The stop cover element is movable with respect to the damper or not fixed with respect to the damper.

As a result, it is possible to limit the maximum spring travel of the spring in order to prevent large compressions and the premature failure of the said spring. In addition, adaptation of the stiffness characteristic can now take place as a function of the vehicle level and freight load. Furthermore, the foot point adjustment does not lead to increased loading of the spring. The stop cover element can now be adjusted independently of the freight loading state of the vehicle. Moreover, the vehicle occupants no longer suffer a loss of comfort on account of the freight loading and the adaptability of the spring stiffness characteristic to the latter since the vehicle oscillates less and maintains contact with the underlying surface.

According to one conceivable refinement of the vibration damper unit, the auxiliary spring can be firmly connected to the counterbearing. As a result, the auxiliary spring is securely fixed even as the stop cover element approaches it or strikes against it or compresses it.

According to one conceivable refinement of the vibration damper unit, the stop cover element forms a stop for the auxiliary spring.

According to one conceivable refinement of the vibration damper unit, the stop cover element can be arranged on the end of a damper housing of the damper. Thus, the stop cover element of the auxiliary spring can be located opposite the auxiliary spring.

According to one conceivable refinement of the vibration damper unit, an adjustment travel (e.g. in respect of direction and length) of the foot point adjusting device can be identical with an adjustment travel of the stop cover element. As a result, it is possible, when adjusting the foot point by a distance, also to adjust the stop cover element by an identical distance in the direction of the auxiliary spring. It is thereby possible to raise the level of the vehicle by means of the foot point adjustment and, at the same time, to suitably limit the maximum spring travel.

According to one conceivable refinement of the vibration damper unit, an adjustment travel (e.g. in respect of direction and length) of the foot point adjusting device can be greater than an adjustment travel of the stop cover element. As a result, it is possible, when adjusting the foot point by a distance, also to adjust the stop cover element by a distance corresponding to a part thereof in the direction of the auxiliary spring. In this case, the foot point adjusting device could, for example, first traverse its own partial adjustment travel while being adjusted in the direction of the stop cover element. After this, it could be connected or coupled to the stop cover element and traverse a further partial adjustment travel together with the stop cover element. It is thereby possible to raise the level of the vehicle by means of the foot point adjustment and, at the same time, to suitably limit the maximum spring travel.

According to one refinement, the vibration damper unit can comprise a connecting element, which connects, can connect, couples or can couple the foot point adjusting device to the stop cover element. By means of the connecting element, it is possible to take account of the different location of the foot point adjusting device and the stop cover element. The foot point adjusting device can, namely, be arranged at one end of the vibration damper unit. The spring can be supported there. The stop cover element, in contrast, can be arranged centrally in the vibration damper unit. There, it can interact with the auxiliary spring. The connecting element serves to transmit the adjustment travel from the foot point adjusting device to the stop cover element. In this way, both elements can remain at their customary locations, irrespective of the possibility for connection or coupling.

According to one conceivable refinement of the vibration damper unit, the connecting element can be guided axially and/or radially by the damper housing of the damper. This avoids noise generation, e.g. rattling. It is thus possible to dispense with additional guidance components. A buffer, e.g. an MCU buffer or a rubber buffer, can be arranged between the connecting element and the damper or damper housing. This avoids noise generation, e.g. rattling.

According to one conceivable refinement of the vibration damper unit, the connecting element can be a hollow cylinder or a hollow cylinder segment of the foot point adjusting device and/or stop cover element. As a result, the connecting element can fit in a simple and space-saving manner around the damper housing.

According to one refinement of the vibration damper unit, the connecting element can be formed by the foot point adjusting device or firmly connected thereto, which connecting element extends in the direction of the stop cover element. As an alternative, the connecting element can be formed by the stop cover element or firmly connected thereto, which connecting element extends from the stop cover element to the foot point adjusting device. It is thereby possible to reduce the number of components. It is conceivable that, in the case of formation by or connection to the foot point adjusting element or the stop cover element, the connecting element can rest loosely against the other of the foot point adjusting element or the stop cover element. This enables one component to traverse a longer adjustment travel than the other component.

According to one conceivable refinement of the vibration damper unit, the connecting element, the stop cover element and at least one part of the foot point adjusting device can be integrally formed. The said part of the foot point adjusting device can be the first or the second wall element. It is thereby possible to further reduce the number of components and to provide a rebound stop. Here, the rebound stop can act both within the foot point adjusting device and at the end of the damper and the stop cover element.

According to one conceivable refinement of the vibration damper unit, the foot point adjusting device and/or the connecting element and/or the stop cover element can be configured in such a way that, in the retracted setting of the foot point adjusting device, the stop cover element is spaced apart axially from the end of the damper. In the retracted setting of the foot point adjusting device, therefore, the stop cover element does not rest on the end of the damper. This prevents direct introduction of force into the end of the damper via the stop cover element, thereby making it possible to avoid damage.

It is conceivable for mutual contact between the travel limiters of the foot point adjusting device to define the axial distance between the stop cover element and the end of the damper via the connecting element. As a result, a pressure force that is introduced into the stop cover element can be introduced into the travel limiters of the foot point adjusting device via the connecting element while cutting out the end of the damper. It is thereby possible to avoid damage to the stop cover element and/or to the connecting element.

According to one conceivable refinement of the vibration damper unit, the connecting element may be the only component which connects the foot point adjusting device to the stop cover element, for which reason it is possible to dispense with additional components for this purpose. A chain of action can pass via the connecting element. Thus, the connecting element can either be assigned to the foot point adjusting device or the stop cover element or can also be of multi-part, e.g. two-part, design, in which case part of the foot point adjusting device and a further part can be assigned to the stop cover element or can be firmly connected thereto or be formed integrally therewith. In the latter case, the parts can extend towards one another and be connected, connectable, coupled or couplable to one another, in particular rest loosely against one another.

According to one conceivable refinement of the vibration damper unit, the connecting element can be formed integrally or in a fixed manner with the foot point adjusting device and/or the stop cover element. If it is connected integrally or firmly with just one of the foot point adjusting device and the stop cover element, it can be supported loosely against the respective other component. A temporary actuating movement can thus be transmitted to the other component but permanent positive coupling can be avoided. If the connecting element is formed integrally or in a fixed manner with the foot point adjusting device and the stop cover element, it can extend between them and form a permanent connection between the two components.

According to one refinement of the vibration damper unit, the stop cover element can rest loosely on the connecting element and/or the damper. The stop cover element is thus not connected firmly to the connecting element and/or the damper. An adjustment travel (e.g. in respect of direction and length) of the foot point adjusting device can therefore partially correspond to the adjustment travel of the stop cover element. As a result, it is possible, when adjusting the foot point by a distance in the direction of the auxiliary spring, also to adjust the stop cover element by an at least partially corresponding distance in the direction of the auxiliary spring. It is thereby possible to raise the level of the vehicle by means of the foot point adjustment and, at the same time, to suitably limit the maximum spring travel. It is conceivable, for example, for the stop cover element to rest loosely on the end of the damper or damper housing. During an adjustment of the foot point in the direction of the auxiliary spring, the stop cover element can be taken along by the connecting element in the course of the adjusting movement, come away from the damper or damper housing and approach the auxiliary spring. If the foot point is then moved away from the auxiliary spring, the stop cover element can come to rest once again on the end of the damper or damper housing.

According to one refinement of the vibration damper unit, the stop cover element can be supported in the axial direction by the connecting element and/or can be supported in the radial direction by the connecting element and/or is supported in the radial direction by the damper. The support can be a sliding bearing arrangement. It is therefore possible to dispense with an additional component for axial bearing and/or radial support to the benefit of a reduced installation space requirement and a reduction in the number of components. It is conceivable for a bearing ring or axial ribs to be provided for the axial support and/or radial support. The bearing ring and/or the axial ribs can be formed by the stop cover element and/or the connecting element and/or the damper or be arranged thereon. The bearing ring offers uninterrupted circumferential bearing/support. In contrast, axial ribs can be formed without an undercut and are suitable for allowing flow of a medium between the axial ribs for pressure compensation. The bearing ring and/or the axial ribs can prevent tilting and jamming of the stop cover element.

According to one refinement of the vibration damper unit, it is possible, in the no-load state of the vibration damper unit and/or a retracted setting of the foot point adjusting device, for a free travel to be formed between the stop cover element and the foot point adjusting device or the connecting element. The free travel can be present in a retracted setting of the foot point adjusting device. The stop cover element can therefore be spaced apart axially from the foot point adjusting device or from a stop cover element contact surface of the foot point adjusting device or from the connecting element or from a stop cover element contact surface of the connecting element. Accordingly, the stop cover element can be taken along by the connecting element or the foot point adjusting device only after traveling a distance corresponding to the free travel, and adjusted in the direction of the auxiliary spring. The adjustment travels of the stop cover element, on the one hand, and the foot point adjusting device, on the other hand, can thus be different. This enables the geometries of the damper and the foot point adjusting device to be chosen independently of one another. By way of the length of the free travel, it is furthermore possible to set the spacing between the auxiliary spring and the stop cover element. The “no-load state” should pertain in the installed position of the vibration damper unit in a motor vehicle without external loading (e.g. a freight load).

According to one conceivable refinement of the vibration damper unit, the foot point adjusting device can be supported on the damper or damper housing. It can be firmly connected to the damper or damper housing. As a result, it can adjust a foot point in the direction of the counterbearing.

According to one conceivable refinement of the vibration damper unit, the foot point adjusting device can have travel limiters, which support the two wall elements on one another in a retracted setting of the foot point adjusting device. It is conceivable for a travel limiter of one wall element to be designed as a cylinder or hollow cylinder and for the travel limiter of the other wall element to be designed as an annular step. In the retracted setting, the cylinder/hollow cylinder and the annular step can be supported on one another.

According to one conceivable refinement of the vibration damper unit, the stop cover element can enter into loose contact with the damper, the damper housing and/or the connecting element on account of the action of gravity.

According to one conceivable refinement of the vibration damper unit, the stop cover element can be a separate component from the damper, from the damper housing, from the connecting element and/or from the foot point adjusting device. This enables the modular use of stop cover elements.

According to one conceivable refinement of the vibration damper unit, the spring can be a helical spring. This serves for optimum functionality of the vibration damper unit with low costs.

According to one conceivable refinement of the vibration damper unit, the stop cover element can comprise a disk portion and a cylindrical lateral surface portion. By means of the disk portion, it can make contact or be contacted, and the lateral surface portion can serve for guidance and protection against tilting.

According to one conceivable refinement of the vibration damper unit, the stop cover element can have a hole, e.g. in the disk portion. The damper rod of the damper can project through the hole.

According to one conceivable refinement of the vibration damper unit, the foot point adjusting device can comprise a first wall element and a second wall element, spaced apart axially from the latter, wherein a chamber at least partially delimited by an elastomer diaphragm is formed between the wall elements. The first wall element can be fixed, e.g. on a fixed structure or a damper or damper housing. The second wall element can be axially movable relative to the first wall element. The chamber can be selectively pressurized by means of fluid pressure or gas pressure in order to move the two wall elements apart. Reducing the fluid pressure or gas pressure leads to the wall elements approaching until a retracted setting is reached. The second wall element can support the spring. The second wall element can form the connecting element or can be connected firmly thereto.

According to the invention, the proposal is furthermore for a vibration damper unit, through which a longitudinal axis projects, comprising a damper with a stop cover element arranged on the end, a foot point adjusting device, a counterbearing, which is situated opposite the foot point adjusting device along the longitudinal axis, a spring, which is supported at one end on the foot point adjusting device and at the other end on the counterbearing, an auxiliary spring, which is arranged between the foot point adjusting device and the counterbearing and is situated opposite the stop cover element along the longitudinal axis, wherein the auxiliary spring is connected, connectable, coupled or couplable to the foot point adjusting device.

This vibration damper unit differs from the vibration damper unit mentioned at the outset in that the auxiliary spring is now connected, connectable, coupled or couplable to the foot point adjusting device instead of to the stop cover element.

By virtue of the fact that the auxiliary spring is connected, connectable, coupled or couplable to the foot point adjusting device, it is possible here too to make two different aspects dependent on one another, namely, on the one hand, the spacing between the auxiliary spring and the stop cover element and, on the other hand, a spring preload. By means of the foot point adjusting device, the auxiliary spring can be adjusted into a position which corresponds to the spring preload. The auxiliary spring is movable with respect to the damper or not fixed to the damper and is also not fixed to the counterbearing. For this purpose, the auxiliary spring is connected, connectable, coupled or couplable to the first or second wall element, or coupled thereto.

As a result, it is possible to limit the maximum spring travel of the spring in order to prevent failure of the said spring. In addition, stiffness adaptations can now take place as a function of the vehicle level and freight load. Furthermore, the foot point adjustment does not lead to increased loading of the spring. The auxiliary spring and the auxiliary spring travel can now be adjusted or set independently of the freight loading state of the vehicle.

The refinements described above in respect of the vibration damper unit should also be taken to be disclosed in respect of the vibration damper unit described here, unless technically excluded. In this context, the intention is to disclose the auxiliary spring and the stop cover element as interchangeable with one another.

According to one conceivable refinement of the vibration damper unit, the stop cover element can be firmly connected to the damper or the damper housing or can be formed thereby.

According to one conceivable refinement of the vibration damper unit, the auxiliary spring can be connected firmly to the foot point adjusting device, preferably to the first or second wall element.

According to one conceivable refinement of the vibration damper unit, the damper or the damper housing can be supported on the counterbearing. The counterbearing can be firmly connected to the damper or damper housing. As a result, the foot point adjusting device can adjust a foot point in the direction of the counterbearing.

### BRIEF DESCRIPTION OF THE DRAWINGS

Further features, details and advantages of the invention can be derived from the wording of the claims and from the following description of exemplary embodiments with reference to the drawings. In the drawings:

FIG. 1a shows a known vibration damper unit in a no-load state;

FIG. 1b shows the vibration damper unit of FIG. 1a in a loaded state with the foot point adjusted;

FIG. 2a shows a vibration damper unit in a no-load state;

FIG. 2b shows the vibration damper unit of FIG. 2a in a loaded state with foot point adjusted;

FIG. 3a shows another vibration damper unit in a no-load state;

FIG. 3b shows the vibration damper unit of FIG. 3a in a loaded state with the foot point adjusted;

FIG. 4 shows another vibration damper unit in a loaded state with the foot point adjusted;

FIG. 5 shows another vibration damper unit in a no-load state; and

FIG. 6 shows another vibration damper unit in a no-load state.

### DETAILED DESCRIPTION

In the figures, identical or mutually corresponding elements are each denoted by the same reference signs and are therefore not described again where this is not expedient. Features that have already been described are not described again in order to avoid repetition, and they are applicable to all elements with the same or mutually corresponding reference signs, unless explicitly excluded. The disclosures contained in the description as a whole can be applied mutatis mutandis to identical parts with the same reference signs or the same component designations. Moreover, the position indications chosen in the description, e.g. top, bottom, lateral etc. refer to the figure currently being described or explained and, in the event of a change of position, can be applied mutatis mutandis to the new position. Furthermore, individual features or combinations of features from the different exemplary embodiments shown and described may also represent independent inventive solutions or solutions according to the invention.

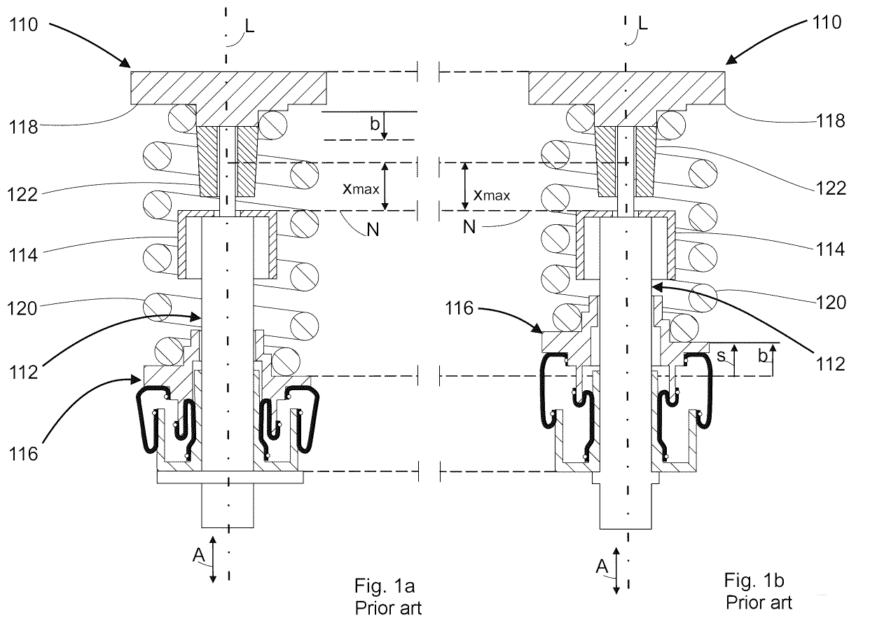

FIGS. 1a and 1b show a known vibration damper unit 110 in the installed position in a motor vehicle in two states. The vibration damper unit 110 is used to damp and cushion shocks on a motor vehicle and on a leveling system. A longitudinal axis L projects through the vibration damper unit 110, wherein the damping action takes place in this direction. Vibration damper unit 110 comprises a damper 112, e.g. a hydraulic damper. A stop cover element 114 is secured on the end of the damper 112. The stop cover element 114 is arranged in a fixed manner on the damper 112, e.g. is connected firmly to a damper housing. The damper rod projects from the damper housing at the same end and is connected to a counterbearing 118.

For leveling of the motor vehicle, the vibration damper unit 110 has a foot point adjusting device 116. The foot point adjusting device 116 comprises a first wall and a second wall, which are spaced apart from one another along the longitudinal axis L and enclose a variable volume, in particular a fluid volume, with at least one diaphragm. The vibration damper unit 110 furthermore comprises the counterbearing 118, which is situated opposite the foot point adjusting device 116 along the longitudinal axis L.

It furthermore comprises a spring 120, in this case illustrated as a helical compression spring, which is supported at one end on the foot point adjusting device 116 and at the other end on the counterbearing 118. The imposition of a force on the foot point adjusting device 116 in the direction of the counterbearing 118 or on the counterbearing 118 in the direction of the foot point adjusting device 116 leads to the compression of the spring 120. To prevent the spring 120 from being overloaded and, in the most extreme case, being fully compressed (the spring 120 is fully compressed and the rings of the spring 120 come into contact with one another), the vibration damper unit 110 has an elastic auxiliary spring 122. The auxiliary spring 122 is arranged between the foot point adjusting device 116 and the counterbearing 118. In addition, the auxiliary spring 122 is situated opposite the stop cover element 114 along the longitudinal axis L. To limit the compression travel, the auxiliary spring 122 can therefore make stop contact with the stop cover element 114.

In the case of dynamic loading, when driving for instance, this vibration damper unit 110 oscillates dynamically around a zero point N. Here, the maximum compression travel Xₘₐₓ is limited by the progression of the auxiliary spring 122.

If the motor vehicle were loaded with freight in this state (FIG. 1a), the spring 120 would yield by a load-dependent travel b. This is depicted in FIG. 1a for illustration purposes. As a result, the auxiliary spring 122 also moves by the travel b towards the stop cover element 114. The motor vehicle is thus lowered on account of the freight load-dependent compression of the spring 120. The leveling system in the form of the foot point adjusting device 116 is now intended to counteract this. In order to achieve the original level of the motor vehicle before freight loading, additional fluid is pumped into the volume of the foot point adjusting device 116, and the volume is thus enlarged, as a result of which a wall of the foot point adjusting device 116 and also the foot point of the spring 120 is moved; this is shown in FIG. 1b. The preloaded spring 122 is adjusted along the longitudinal axis L and pushes the counterbearing 118 and thus also the motor vehicle to the original level.

It can be seen that the foot point of the spring 120, which is located on the same side as the foot point adjusting device, is moved in the direction of the counterbearing 118, e.g. precisely back by the travel b. However, the original spacing between the auxiliary spring 122 and the stop cover element 114 before the freight loading of the motor vehicle is thereby also re-established. This side effect is associated with considerable disadvantages.

With the same dynamic loading (in comparison with the vibration damper unit 110 in the original and no-load state as per FIG. 1a), the vibration damper unit 110 oscillates in a dynamic way around the zero point N in this state too, as per FIG. 1b. This is also due to the fact that the spring 120 does not have a progressive behavior. As shown in FIG. 1b, the maximum compression travel Xₘₐₓ in this state too is again limited by the progression of the auxiliary spring 122. However, the spring 120 has already been compressed and preloaded by the preload travel s on account of the freight loading. It is assumed here: s=b. Consequently, the spring 120 is subject to a greater load by the travel b and may fail prematurely.

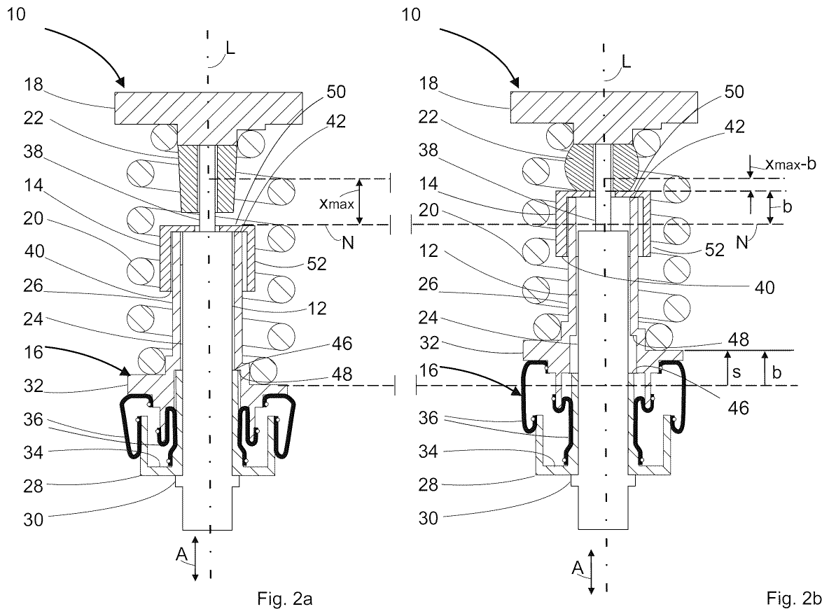

FIGS. 2a and 2b show one embodiment of the vibration damper unit 10 in the installed position in a motor vehicle in two states in a longitudinally sectioned view. FIG. 2a shows an unladen state of the vehicle with the foot point adjusting device 16 retracted. FIG. 2b, in contrast, shows a laden state of the vehicle with the foot point adjusting device 16 extended.

The vibration damper unit 10 is used to damp and cushion shocks on a motor vehicle and on a leveling system. A longitudinal axis L with a corresponding axial direction A projects through the vibration damper unit 10, wherein the damping action takes place in this direction. The vibration damper unit 10 comprises a damper 12, e.g. a hydraulic damper, having a damper housing 24 and a damper rod 38. A stop cover element 14 rests loosely on the end of the damper 12. The damper rod 38 projects from the damper housing 24 at the same end and is connected to a counterbearing 18.

For leveling of the motor vehicle, the vibration damper unit 10 has a foot point adjusting device 16. The foot point adjusting device 16 comprises a first wall element 28, which is supported on a support ring 30 of the damper 12 and is firmly connected to the damper housing 24. The foot point adjusting device 16 comprises a second wall element 32, which is spaced apart axially from the first wall element 28. The second wall element 32 is axially movable relative to the first wall element 28 and is guided on the damper housing 24. Arranged between the wall elements 28, 32 is a chamber 34, which is delimited on both sides in the radial direction by respective elastomer diaphragms 36. By means of adjustable gas and/or fluid pressure in the chamber 34, the axial spacing between the two wall elements 28, 32 can be adjusted. In the next setting of the two wall elements 28, 32 with respect to one another, the foot point adjusting device 16 has a retracted setting, shown in FIG. 2a. The first wall element 28 has a travel limiter 46 in the form of a hollow cylinder, which extends along the longitudinal axis L in the direction of the second wall element 32. The second wall element 32 has a travel limiter 48 in the form of an annular step. In the retracted setting shown, the hollow cylinder and the annular step are supported upon one another.

The vibration damper unit 10 furthermore comprises the counterbearing 18, which is situated opposite the foot point adjusting device 16 along the longitudinal axis L.

The vibration damper unit 10 furthermore comprises a spring 20, in this case illustrated as a helical compression spring, which is supported at one end on the second wall element 32 of the foot point adjusting device 16 and at the other end on the counterbearing 18. The imposition of a force on the foot point adjusting device 16 in the direction of the counterbearing 18 or on the counterbearing 18 in the direction of the foot point adjusting device 16 leads to the compression of the spring 20. To prevent the spring 20 from being overloaded or, in the most extreme case, being fully compressed (the spring 20 is fully compressed and the rings of the spring 20 come into contact with one another), the vibration damper unit 10 has an elastic auxiliary spring 22. The auxiliary spring 22 is connected at a fixed location to the counterbearing 18, e.g. by means of a clamping fit or of a form fit. The auxiliary spring 22 is arranged between the foot point adjusting device 16 and the counterbearing 18. In addition, the auxiliary spring 22 is situated opposite the stop cover element 14 along the longitudinal axis L. To limit the compression travel, the auxiliary spring 22 can therefore make stop contact with the stop cover element 14 and be compressed. The stop cover element 14 forms a stop for the auxiliary spring 22. The stop cover element 14 has a disk portion 50 and a cylindrical lateral surface portion 52.

The vibration damper unit 10 furthermore comprises a connecting element 26, which is designed as a hollow cylinder portion of the foot point adjusting device 16. The connecting element 26 is formed integrally with the second wall element 32 and extends to the stop cover element 14. In the retracted setting of the foot point adjusting device 16, the stop cover element 14 rests loosely against the end of the connecting element 26. The connecting element 26 therefore serves to connect or couple the foot point adjusting device 16 to the stop cover element 14. The connecting element 26 is guided axially and radially by the damper housing 24. The connecting element 26 provides a sliding bearing in the axial direction A and support in the radial direction for the stop cover element 14. For this purpose there is a bearing ring or axial ribs 40, which are provided in the radial space between the stop cover element 14 and the connecting element 26. The axial ribs 40 are formed by the stop cover element 14 and are arranged on the lateral surface portion 52 thereof.

In the case of dynamic loading, when driving for instance, this vibration damper unit 10 oscillates dynamically around a zero point N. Here, the maximum compression travel Xₘₐₓ is limited by the progression of the auxiliary spring 22.

Adjustment of the second wall element 32 by the travel b by changing the pressure within the chamber 34 adjusts the second wall element 32 in the axial direction A towards the auxiliary spring 22, as FIG. 2b shows. At the same time, the connecting element 26 and also the stop cover element 14 are also adjusted by the identical travel b in the direction of the auxiliary spring 22—the auxiliary spring 22 is compressed. The maximum spring travel Xₘₐₓ is shortened by the travel b. In addition, the spring 22 is thereby compressed. After the motor vehicle has been loaded with freight, the original level before freight loading is re-established by adjusting the foot point of the compressed spring 22, as FIG. 2b shows. The adjustment travel of the foot point adjusting device 16 is identical with the adjustment travel of the stop cover element 14 as long as the stop cover element 14 and the connecting element 26 are coupled. The shortened auxiliary spring travel takes account of the likewise shortened spring travel.

With the same dynamic loading (compare: the vibration damper unit 10 in the original and no-load state as per FIG. 2a), the vibration damper unit 10 oscillates in a dynamic way around the shifted zero point N+b in the state shown in FIG. 2b. This is also due to the fact that the spring 20 does not have a progressive behavior. As shown in FIG. 2b, the maximum compression travel Xₘₐₓ in this state too is again limited by the progression of the auxiliary spring 22. The spring 20 has been compressed and preloaded by the preload travel s on account of the freight loading. However, the auxiliary spring travel is also as it were shortened, and the maximum compression travel Xₘₐₓ is shortened by the travel b. At the maximum compression, the spring 20 is consequently not more severely loaded, irrespective of the position of the foot point adjustment shown in FIGS. 2a and 2b, and no longer fails prematurely.

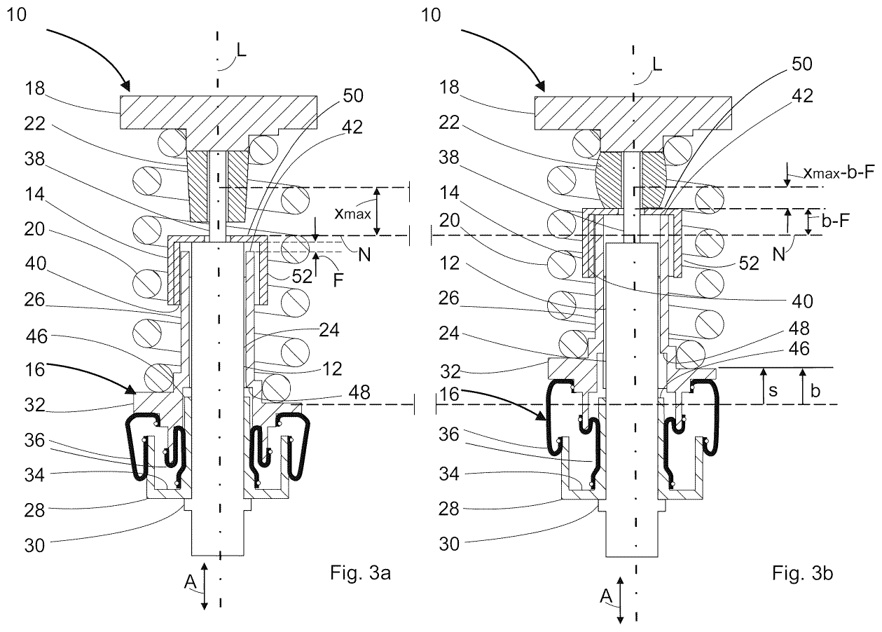

FIGS. 3a and 3b show another embodiment of the vibration damper unit 10 in the installed position in a motor vehicle in two states in a longitudinally sectioned view. FIG. 3a shows an unladen state of the vehicle with the foot point adjusting device 16 almost retracted. FIG. 3b, however, shows a laden state of the vehicle with the foot point adjusting device 16 extended. To avoid repetition, only the differences with respect to FIGS. 2a and 2b will be described below, while the remaining aspects apply analogously.

The connecting element 26 is now of somewhat shorter design at the end, and it therefore no longer reaches as far as the stop cover element 14 when the foot point adjusting device 16 is in a retracted setting. A free travel F is formed between the stop cover element 14 and a stop cover element contact surface 42 of the foot point adjusting device 16. The adjustment travel of the foot point adjusting device 16 (travel b) is greater than an adjustment travel of the stop cover element 14 (travel b-F).

The stop cover element 14 is accordingly taken along by the connecting element 26 only after traveling a distance corresponding to the free travel, and is adjusted in the direction of the auxiliary spring 22 by the travel b-F. In this case, the stop cover element contact surface 42 rests against the stop cover element 14. The adjustment travels of the stop cover element 14, on the one hand, and the foot point adjusting device 16, on the other hand, are thus different. The auxiliary spring travel is shortened less than without the free travel F, the result being Xₘₐₓ-b-F.

If the second wall element 32 is now moved away from the auxiliary spring 22 again, the connecting element 26 sets down the stop cover element 14 on the end of the damper housing 24 and re-establishes the free travel F, wherein the set down or return of the stop cover element 14 can take place under the action of gravity. The axial ribs 40 are designed as separate parts on the inner circumference of the stop cover element 14.

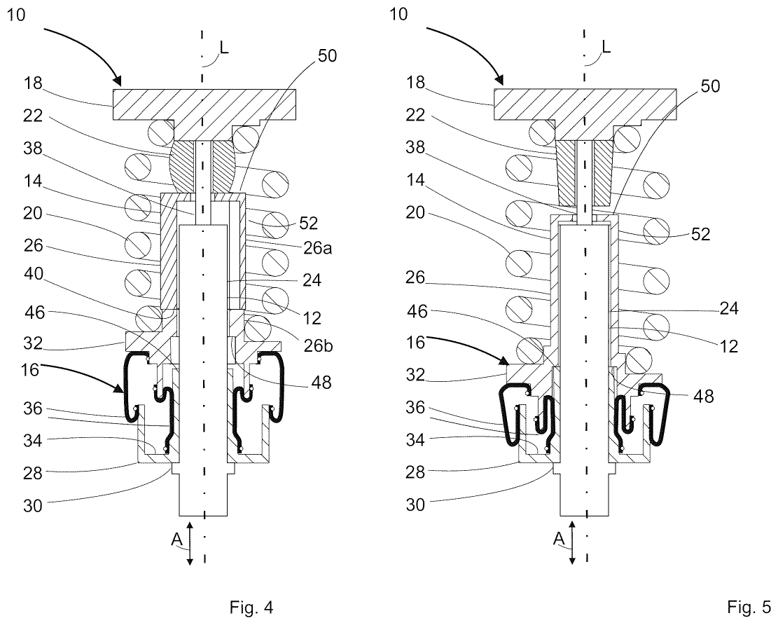

FIG. 4 shows another embodiment of the vibration damper unit 10 in the installed position in a motor vehicle in the extended setting of the foot point adjusting device 16 in a longitudinally sectioned view. To avoid repetition, only the differences with respect to FIGS. 2a and 2b will be described below, while the remaining aspects apply analogously.

The connecting element 26 is now of two-part design, wherein one part 26a is formed integrally with the stop cover element 14, and another part 26b is formed integrally with the foot point adjusting device 16 or the second wall element 32. Both parts 26a, 26b are hollow cylindrical portions of their respective component. The two parts 26a, 26b extend towards one another and rest loosely upon one another. Purely by way of example, no axial ribs 40 are shown here.

FIG. 5 shows a vibration damper unit 10 in the installed position in a motor vehicle in a retracted setting of the foot point adjusting device 16 in a longitudinally sectioned view. To avoid repetition, only the differences with respect to FIG. 4 will be described below, while the remaining aspects apply analogously.

The stop cover element 14, the connecting element 26 and the second wall element 32 are integrally formed. The two travel limiters 46, 48 rest against one another, and the stop cover element 14 is spaced apart axially from the end of the damper 12.

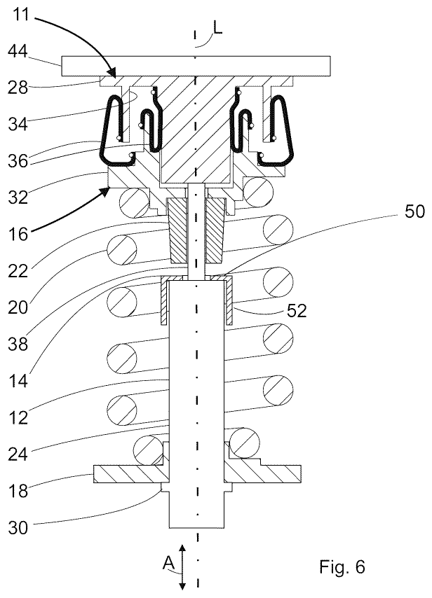

FIG. 6 shows a vibration damper unit 11 in the installed position in a motor vehicle in a retracted setting of the foot point adjusting device 16 in a longitudinally sectioned view. To avoid repetition, only the differences with respect to FIGS. 2a and 2b will be described below, while the remaining aspects apply analogously.

As regards the functional principle, the vibration damper unit 11 is equivalent to the vibration damper unit 10 described hitherto since the distance from the stop cover element 14 to the auxiliary spring 22 can be set by means of the foot point adjusting device 16. Now, however, the auxiliary spring 22 is connected, connectable, coupled or couplable to the foot point adjusting device 16 instead of to the stop cover element 14.

The stop cover element 14 is firmly connected to the damper housing 24. A connecting element 26 is not provided since the foot point adjusting device 16 is situated opposite the end of the damper housing 24, and the auxiliary spring 22 is connected directly and firmly to the second wall element 32. The damper housing 24 now supports the counterbearing 18 via its support ring 30. The foot point adjusting device 16 is fixed on a fixed structure 44.

Adjustment of the second wall element 32 adjusts the auxiliary spring 22 in the direction of the stop cover element 14 and thereby shortens the auxiliary spring travel and also the maximum spring travel. At the same time, the spring 20 is compressed.

The invention is not restricted to one of the above-described embodiments but can be modified in a variety of ways. All the features and advantages which emerge from the claims, the description and the drawing, including design details, spatial arrangements and method steps, may be essential to the invention either per se or in a wide variety of combinations.

All combinations of at least two of the features disclosed in the description, the claims and/or the figures fall within the scope of the invention.

To avoid repetition, features disclosed in terms of a device should also be taken to be disclosed and claimable in terms of a method. Likewise, features disclosed in terms of a method should also be taken to be disclosed and claimable in terms of a device.

1. A vibration damper unit, through which a longitudinal axis projects, comprising:
a damper with a stop cover element arranged on the end face,
a foot point adjusting device,
a counterbearing situated opposite the foot point adjusting device along the longitudinal axis,
a spring supported at one end on the foot point adjusting device and at the other end on the counterbearing, and
an auxiliary spring arranged between the foot point adjusting device and the counterbearing and situated opposite the stop cover element along the longitudinal axis,
wherein the stop cover element is connected, connectable, coupled or couplable to the foot point adjusting device.

2. The vibration damper unit according to claim 1, including a connecting element, which connects, can connect, couples or can couple the foot point adjusting device to the stop cover element.

3. The vibration damper unit according to claim 2, wherein the connecting element is formed by the foot point adjusting device or is firmly connected thereto, the connecting element extends in the direction of the stop cover element, and/or the connecting element is formed by the stop cover element or is firmly connected thereto, which connecting element extends from the stop cover element to the foot point adjusting device.

4. The vibration damper unit according to claim 2, wherein the stop cover element rests loosely on the connecting element and/or the damper.

5. The vibration damper unit according to claim 2, wherein the stop cover element is supported in the axial direction by the connecting element and/or is supported in the radial direction by the connecting element and/or is supported in the radial direction by the damper.

6. The vibration damper unit according to claim 1, wherein, in a no-load state of the vibration damper unit and/or a retracted setting of the foot point adjusting device, a free travel is formed between the stop cover element and the foot point adjusting device or the connecting element.

7. A vibration damper unit, through which a longitudinal axis projects, comprising:
a damper with a stop cover element arranged on the end face,
a foot point adjusting device,
a counterbearing situated opposite the foot point adjusting device along the longitudinal axis,
a spring supported at one end on the foot point adjusting device and at the other end on the counterbearing, and
an auxiliary spring arranged between the foot point adjusting device and the counterbearing and situated opposite the stop cover element along the longitudinal axis,
wherein the auxiliary spring is connected, connectable, coupled or couplable to the foot point adjusting device.
